(19) United States
(12) Patent Application Publication
(10) Pub. No.: US 2012/0245925 A1
(43) Pub. Date: Sep. 27, 2012

(54) METHODS AND DEVICES FOR ANALYZING TEXT

(76) Inventors: Aloke Guha, Louisville, CO (US); Kirill Kireyev, Mountain View, CA (US); Andrew Lampert, Marsfield (AU); Kapil Tundwal, Denver, CO (US)

(21) Appl. No.: 13/429,435

(22) Filed: Mar. 25, 2012

Related U.S. Application Data
(60) Provisional application No. 61/467,499, filed on Mar. 25, 2011.

(51) Int. Cl. G06F 17/27

(52) U.S. Cl. 704/9

(57) ABSTRACT

A method, operating model, system, method, computer program, application, online service, or application program interface (API) Application Program Interface (API), and computer program product for analyzing any email message or text, online post, online web pages, social media sites, and online news sites to detect predefined and actionable events and intent. A method for detecting important emails or messages, and actionable emails or messages that signify intent including questions or promises. A method for detecting past or possible future events in any online posts where the event is defined a priori.

This application claims priority to U.S. provisional application 61/467,499 for ANALYZING EMAILS AND MESSAGES TO DISCOVER IMPORTANT COMMUNICATION AND ACTIONABLE INTENT, filed on Mar. 25, 2011, which is incorporated by reference for all that is disclosed therein.

### BACKGROUND

As the world has moved into an always-on, real-time mode, traditional methods of “news” or information sharing now occurs between individuals and groups using email or other messaging platforms or on websites and social media sites. The online information delivery has now overtaken the ability of traditional news services. Email, SMS, blogs, as well as social media networks, have become the early indicators of what is happening both at a personal and at the public level.

The increased speed of delivery and accessibility to news creates opportunities to better understand developing scenarios even as the growing volume of content creates challenges in sifting, filtering and identifying actionable information about the future.

While prior art has relied on descriptive and collocated keywords and frequently used keywords and a priori machine learning or training to prioritize important email messages, these approaches are limited in detecting specific events or intent. The reason is that relying on filtering based on a static set of keywords cannot comprehend that there is an intent in the message such as a question, an order, a commitment or promise, give thanks, offer apologies, etc., collectively referred to as “speech acts.”

Some recent approaches in speech act detection have employed natural language processing (NLP) which would require understanding the language and the grammar. An example of this technique is using machine learning-based classifiers for detecting some email speech acts based on prior training. These classifiers may use n-gram selection, where n-gram refers to a contiguous sequence of n items from a given sequence of text or speech such as phonemes, syllables, letters, words, etc. One implementation of this approach is an email system that can identify the speech act of each sentence in an email message and perform actions appropriate to the speech act.

The challenge in developing a general-purpose event detection system is that it has to detect not only actionable intent such as speech acts but also specific classes of event occurrence.

### SUMMARY

An embodiment for analyzing text provides a system, method, a computer program, application, online service, and/or application program interface (API) for detecting predefined events or intent in any online communications from messaging texts to online web posts. This includes detecting intent such as a question or request, commitment to a request or to purchase, or detecting sensitive information, such as those related to privacy or medical information, being leaked in a message or post. Further, the event analytics engine can be customized to detect almost any class of intent or event, and therefore can be applicable to wide range of use cases from customer support to lead generation.

The event detection engine combines natural language capability with an efficient, pipelined processing architecture so as to create real time customized event detection framework. The text extracted from any source, whether a messaging platform, web page, or social media site, is parsed against predefined linguistic rules. These rules are specific to the class of events or intent that needs to be detected and codify the type of actors involved in the event and the type of action being monitored. Depending on the specific event and the use case, the detection logic can include signals such as entity name, which include persons, organizations, locations such as GPS coordinates or explicit place names, expressions of times, quantities, monetary values, percentages, etc), as well as sentiment or opinion on the entity or the text, etc.

The grammar rules are derived from the event or event class being defined. There are multiple methods to develop a corpus of sample or training data to build the event detection logic. This includes well-known primary language constructs of the event using action verbs representing the event or intent, alternate language constructs which includes constructs using synonyms of the action verbs or phrases with similar meaning as well as specialized constructs such as ad hoc idiomatic expressions. In addition, a corpus comprising examples of language constructs from actual usage instances may be used.

Once the set of language constructs have been compiled, they are analyzed for common grammar constructs to identify common n-grams sequences. As part of the analysis, verb classes, subject and object of the verbs including pronouns and implied pronouns are identified as required. The set of common n-grams and associated parts of speech values are used to create the minimal set of grammar rules required for the event detection. The minimal grammar rule set is used so that the parsing and application of grammar rules can be efficiently executed in real-time on a single computing device such as a smart mobile phone (smartphone) or a client computer such as an email client.

The final determination of whether an event of interest has been detected is embodied in an event detection logic module. The event detection logic is defined by the grammar rules in combination with event signals, which include such concepts or entities such as specific names, location or time, or even sentiment or mood or opinion, that indicate the occurrence of the event.

The accuracy of the event detection engine is improved by continually updating the grammar rules and/or the event detection logic when user feedback is available, either explicitly or implicitly.

The methods may be implemented for multiple application where event and especially intent detection is important such as: a lightweight client application for a commercial email system such as Microsoft Outlook®, a plug-in for web mail such as Gmail® or Yahoo Mail®, applications (apps) for smart phones such as Blackberry®, iPhone® and Android®, and as a stand-alone web API such as a callable REST/JSON API that can be offered as a service to end users or 3^{rd} party applications.

Implementations of the event detection analytics differ depending on whether the embodiment is on an end or client device like a phone, email or tablet, or on a server as a backend web service. For instance, when the analytics are for email intent detection on a smartphone or computer tablet, it can be implemented as a part of the native email client. Also, based on user feedback the client application can update its event detection analytics module to improve its accuracy.

When the event detection analytics is embodied as a Web API service, then the embodiment can be hosted on a web application hosting service such as Google App Engine® or Heroku®. The API in such a case can be a REST/JSON based API that allows users to send the text to be analyzed and have the API return the detected events or intents. The underlying components of the analytics engine are the same as in the case of the email client.

### BRIEF DESCRIPTION OF THE DRAWINGS

FIG. 1 is a block diagram of an embodiment of a method for analyzing text.

FIG. 2 is a block diagram of another embodiment of a method for analyzing text.

FIG. 3 is a block diagram of another embodiment of a method for analyzing text.

FIG. 4 is a flow chart describing an embodiment for the construction of grammar rules.

FIG. 5 is a diagram of an intent detection email analytics on a smart phone.

FIG. 6 is a diagram of an intent detection analytics API on a web application platform.

FIG. 7 is a diagram showing intent detection in a web mail system.

FIG. 8 is an example of a web site displaying information pertaining to analyzed text using different embodiments

FIG. 9 is a diagram of event detection within an email web robot (bot).

FIG. 10 is an embodiment of a definition table for email status flags.

FIG. 11 is an example of intent detection and tracking displayed in an email client.

FIG. 12 is an example of a flagged email message having a question within the message.

FIG. 13 is an example of flagged email messages having Questions and Commitments within the messages.

FIG. 14 is an embodiment of email folders organized by detected intent.

FIG. 15 is an embodiment of a display of important contacts related to emails.

FIG. 16 is an embodiment of an intent detection email bot.

FIG. 17 is an embodiment of an intent detection plug-in for web mail

FIG. 18 is an embodiment of API based implementation of intent detection.

FIG. 19 is an embodiment of event detection on a social media website.

FIG. 20 is an embodiment of a dashboard showing intent detection and tracking in customer and support personnel emails.

FIG. 21 is a special purpose computer system configured with an event detection system according to one embodiment.

### DETAILED DESCRIPTION OF THE EMBODIMENTS

Analyzing text to detect events of interest relies on analyzing related data from many sources and using methods as described herein for specific purposes. With large scale search and data mining capabilities it is possible to find minuscule mentions of subtle indications about what is to come and detect early signals of such events. A related problem is how to detect specific events that one expects to occur, or detect a possible event by detecting a person's intent from the messages or online information sources.

Examples of event detection of practical interest include detecting intent such as questions and commitments in messages from within personal to business emails for increasing productivity, managing customer relationships in service organizations, generate sales leads, manage and create marketing campaigns, and analyze and segment customer data for product and service development.

This application describes a method for analyzing messaging and online posts to detect the occurrence of a pre-defined event including a possible future event based on detecting certain context and conditions. The method can applied to filter large amounts of online information and detect specific events from any online source and on any client device, from desktops to computer tablets and smartphones.

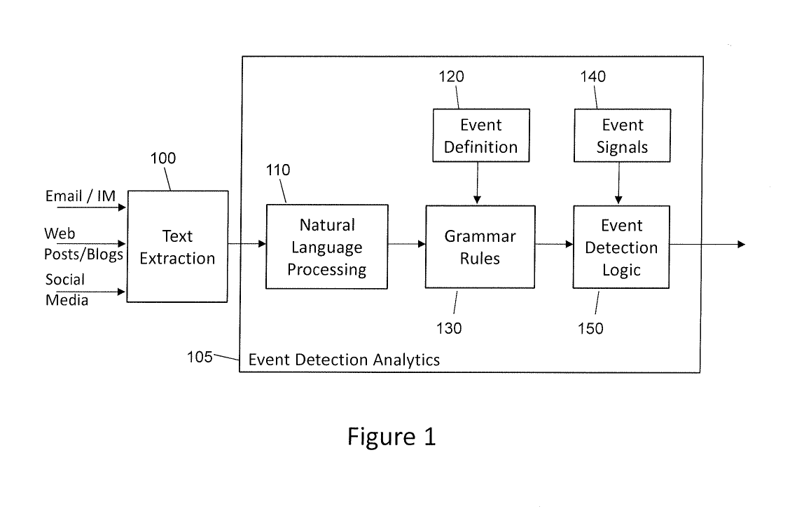

FIG. 1 shows a general event detection system for the devices and methods described herein. As shown, the method works for any text provided from any source including email and messages from a messaging application like chat or instant messaging (IM), data posted on a web site or blog, and social media sites such as Facebook® or Twitter®. Text is extracted from these sources by the Text Extraction module 100 and then passed to the event detection analytics module 105. The event detection analytics module may include at least the following primary components: natural language processing (NLP) unit 110, event detection unit 120, grammar rules unit 130, event signals unit 140 and the event detection logic unit 150.

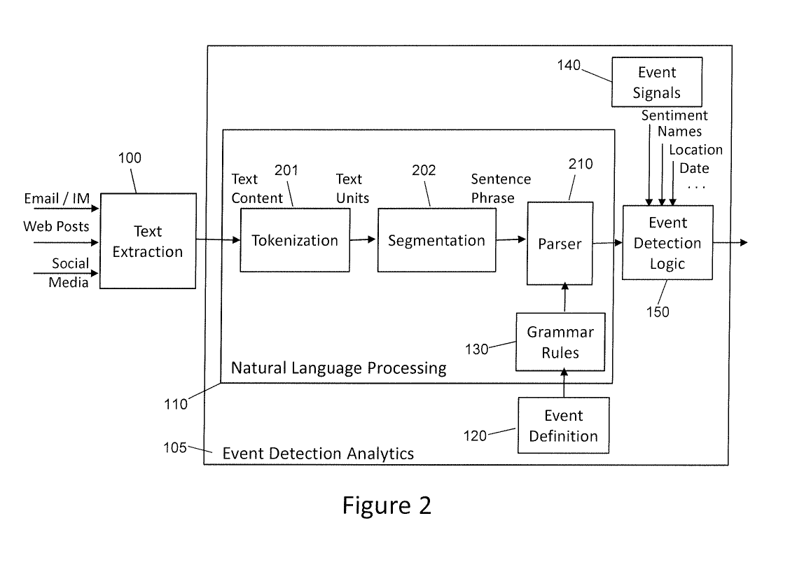

Once the text has been extracted 100 from the source, the NLP unit 110 applies the following steps as shown in FIG. 2. In the first step 201, the text is tokenized or the body of the extracted text is broken down to units referred to as “tokens” which may be words or numbers or punctuation marks. Tokenization does this task by locating word boundaries. Tokenization thus identifies all words in the text.

In the second step, the tokenized text is segmented 202. Segmentation divides the string of text units into its component sentences or the stand-alone phrases. Typically, in English and similar languages, punctuation marks such as period or full stop or semi-colon characters are used to denote the end of a sentence or stand-alone phrase.

Once the tokenized text has been segmented, in the third step the sentences or phrases obtained from segmentation are parsed for grammar 210. Parsing identifies the grammatical structure of sentences, i.e., which groups of words go together such as a phrase, the tagged parts of speech, and the words that are the subject or object of the verb phrase. Once the grammatical structure has been derived, the meaning of the sentence is possible based on the application of relevant grammar rules.

The grammar rules 130 to be applied are defined by the event 120 that is to be detected. Since grammar for natural languages can be ambiguous, a sentence or phrase can have multiple possible analyses and therefore meanings. By applying rules of grammar that are specific to the event, the meaning behind the sentence can be derived. In this application, a grammar rule therefore refers to the rule or condition that a sequence of parsed text must satisfy to indicate an event or intent category. Thus, a grammar rule can specify that the parsed units in the text, such as noun, verb phrases, or adjective, and their combinations meet certain predefined conditions and values. It can include determination of the subject of the verb and the person, 1^{st}, 2^{nd} or 3^{rd}, of the subject and object

In many cases, the event or intent detection may include event signals 140. These signals may be independent of the grammar rule conditions. For example, if the intent to be detected is a promise by the sender of a message or post, such as, “I will be going”, then an intent to go on a certain day would look for a date or day, such as “today”, “tomorrow”, or “Tuesday”. Thus, a commitment intent to go on a certain day would be detected if the grammar rule detects a commitment involving “going” or “traveling” and a co-located mention of a day such as specific weekday, (Monday through Sunday), or today or tomorrow. The latter condition on the day would be checked by the event detection logic that analyzes both the output of the parser 210 and the event signals 140.

In addition to the use of event signals, the event detection logic may check for a match of the noun phrases with predefined key phrase of interest. Key phrases of interest refer to specific topics or names of entities, including persons, places, locations, products, or services.

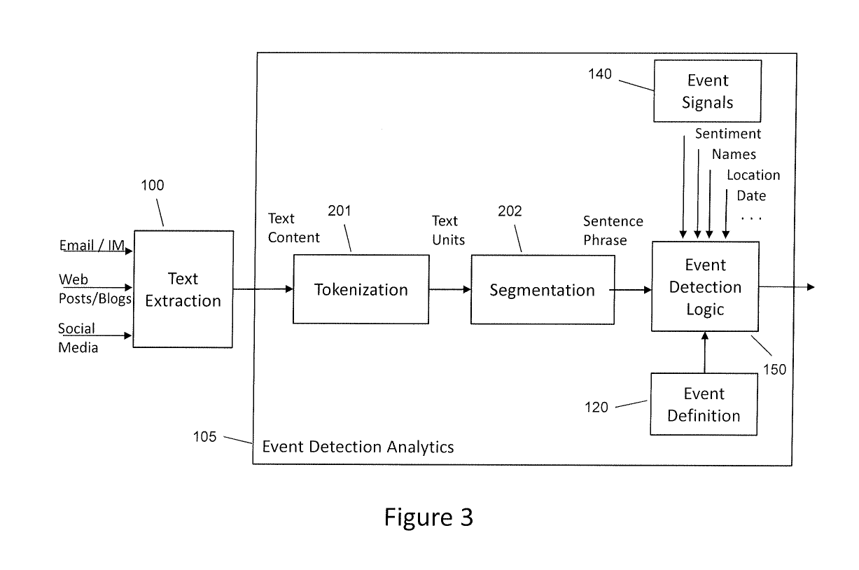

There are at least two possible implementations of the event detections analytics module 105. The first includes parsing 210 with grammar rules 130 as shown in FIG. 2. Alternately, as shown in FIG. 3, the event detections analytics module 105 can be built without need for parsing but only use an event detection logic 150 on the parsed text units. Thus, detecting any event about an entity such as a smartphone would require getting the output of the segmentation 202 and doing a match on the noun phrases with the specific smartphone. No grammar rules may be required.

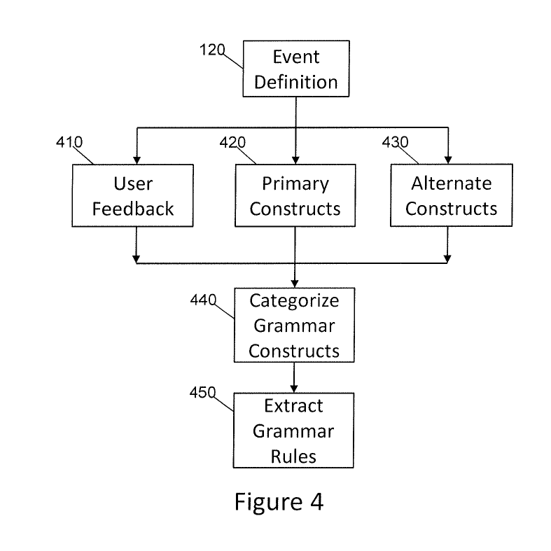

For complex event detection, event detection analytics 105 will include a parser 210 and grammar rules 130. One approach to deriving grammar rules 105 from an event definition 120 is shown in the flowchart of FIG. 4.

Event detection 120 will typically include explicit specification of the type of event to be detected, i.e., what type of actors are involved in what action or an action that occurred in nature. This can include an event definition of the type: an intent like a question being asked of the receiver, a commitment intent by the sender or poster of the message relating to an interest in purchasing a specified item, to the occurrence of rain. Once the event is specified, different possible linguistic construct are considered. This can include well-known primary language constructs 410 that describe the event using action verbs representing the event. It can include linguistic constructs 430 description which includes synonymous expressions of the primary construct with use of sentences or phrases that indicate similar or equivalent descriptions of the event. Alternate constructs 430 can also include colloquial or ad hoc idiomatic expressions. Another form of language constructs would be from a corpus comprising examples of language constructs that indicate the event and collected from actual user feedback 410.

Once the set of language constructs have been compiled, they are analyzed for common grammar constructs to identify common patterns such as frequently observed n-grams sequences, common verb phrases, and associated parts of speech values. This analysis step then categorizes 440 the complied constructs into a set of common grammatical constructs 440. Each set of common grammatical construct is converted into a formal grammar rule.

One desired constraint in creating the set of grammar rules is to select the minimal set of rules required for the event detection. Using the minimal number of grammar rules ensures the most efficient parsing of the text and the application of grammar rules. Having the smallest set of grammar rules not only results in the shortest processing time in event detection but also reduces the memory footprint. This in turn enables running the event detection system to on a single computing device such as a smartphone, a computer tablet, or a client computer such as an email client.

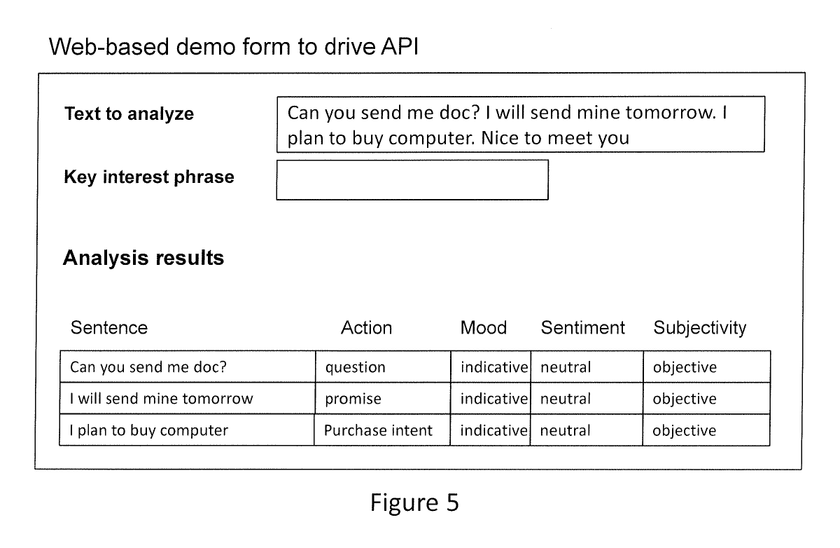

A number of embodiments of the event detection, especially intent detection, in emails or any text, have been implemented as shown in the demo web site page shown in FIG. 5. The embodiments in this demo web site include a web HTTP API, a smartphone library such as for a commercial operating system as Android®, and for an email client such as for Microsoft Outlook®.

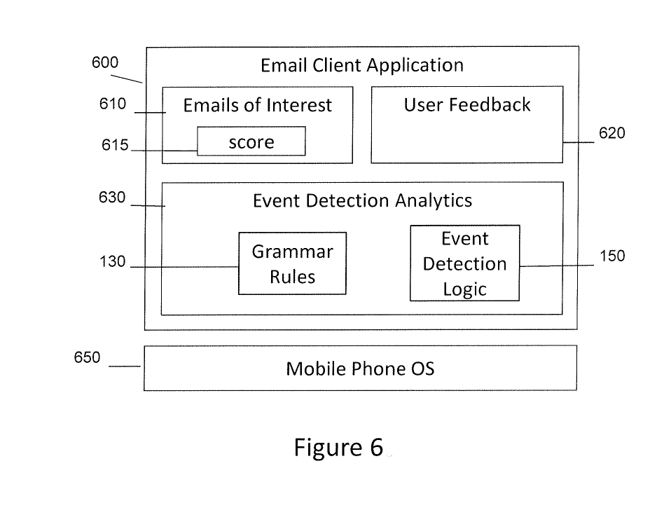

An efficient event detection processing system allows implementation across many different devices, from a smartphone to a server. These different embodiments are now described in FIGS. 6 to 9.

FIG. 6 shows an embodiment of a special case of event detection, intent detection for emails, in a smartphone. In this embodiment, the email client application 600 that runs on a mobile phone operating system 650, such as Android®, is modified to include the event detection analytics module 630. As with all email clients, the client application fetches and stores emails locally using IMAP or POP3 protocols without user supervision. Upon receiving new emails of interest 610, the analytics gives them a score 615 depending on the confidence level of detecting intent such as a question or request, or commitment or promise. In addition, the embodiment may allow the user to review the intent score or flag and provide feedback 620 to the client. The feedback can then be used to update the grammar rules 130 and/or event detection logic 150 for accuracy improvement.

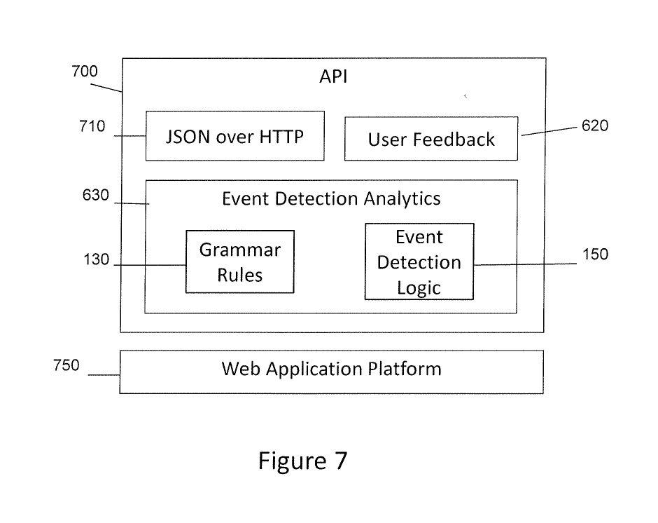

FIG. 7 shows event detection analytics powering an API 700 running on web application platform 750. The API 700 can be called over HTTP 710 to analyze text for a given source. As with the previous embodiment the event detection analytics analyzes the email and assigns the score for the intent. As with the other embodiments, the event detection analytics 630, grammar rules 130 and/or event detection logic 150, can be updated with each API call and stored on the server with user feedback 620 without any user supervision.

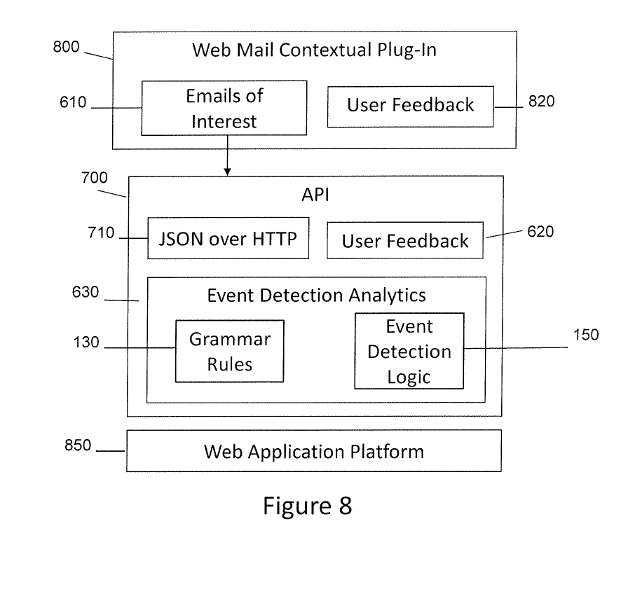

FIG. 8 shows event detection analytics 630 used within a web mail, such as Gmail® contextual plug-in 800. The email 610 is provided to the plug-in 800 by the API 700 as in the case of the web API described in FIG. 7. The API 700 assigns the score for the intent and provides the result to the user via the plug-in 800. User feedback 820 is provided by the plug-in 800 to the API 700 to update the event detection analytics 630.

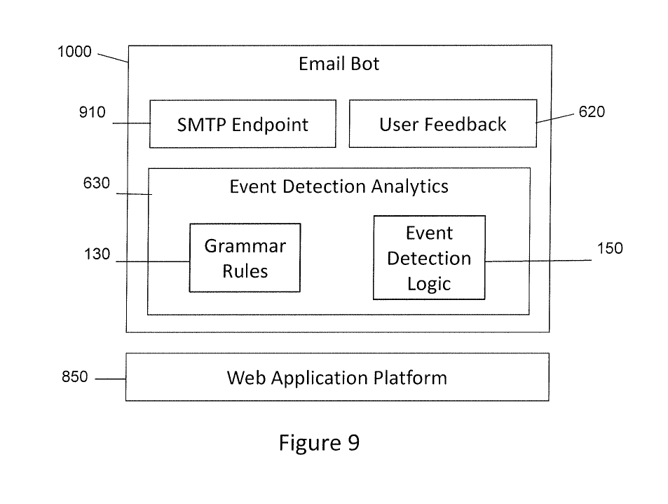

FIG. 9 shows event detection analytics 630 powering an SMTP endpoint 910 running on a web application platform 850 for implementing an email web robot or bot 1000. The bot 1000 is called over SMTP 910 to analyze text in the body of email. As before the event detection analytics 630 calculates the intent score when an intent is detected. The event detection analytics 630 can be updated with each SMTP call and stored on server with user feedback 620.

Having summarily described some embodiments of the devices and methods, more detailed descriptions will now be provided. The methods and devices described herein may be used in the following applications:
Email including email on smart phones and desktop email;
Web based API for general web applications, including CRM, social media marketing and engagement; and
General event detection such as sensitive information or data leak protection (DLP).

Described herein and as shown in FIGS. 1-4 are techniques for a generalized intent detection system, including an email analysis system. Although the approach uses email and messaging system as an example, it is directly applicable to any electronic posts or communication such as social media posts, comments, and chat. In the following description, for purposes of explanation, numerous examples and specific details are set forth in order to provide a thorough understanding of embodiments of the present invention. Particular embodiments as defined by the claims may include some or all of the features in these examples alone or in combination with other features described below, and may further include modifications and equivalents of the features and concepts described herein.

### Email Message Intent Detection Approach

Particular embodiments analyze emails so as to detect:
Action Item or Request Emails—those that have questions or requests from a sender for the user and needs a response;
Commitment Emails—the counterpart to Action Items—those in which the sender promises or offers to complete or execute an action; and
Intent to Purchase—e.g., of a special derivative case of Commitment that uses Commitment Detection logic and other signals to build this Intent Detection.

Particular embodiments identify many different types of email based on a number of factors. Thus, in addition to identifying which emails should be flagged as Action Item or Commitment that the user needs to read, particular embodiments also identify messages that are important to the user. While there are many possible factors that determine what messages are important to the user, there are some criteria that are used in defining importance. Some key factors that determine importance of a message may include:
Sender: not all senders are equally important; every user has key working or subordinate or personal relationships with few contacts. The user has frequent conversations with these contacts. Therefore, messages from these contacts may have higher priority than those from other contacts. Further, even among contacts that the user converses with, there will be a relative order of importance.
Content Topics: there may be explicit topics that the user may be discussing currently that will take precedence over topics that were discussed in the past. For example, the user may be discussing a current client's project that may be evident in recent emails but not a completed project that had been a topic of discussion in the past.
Unstated Intent: there may be implicit topics or intent that the user may be considering that are not expressed in the user's message content. For example, if the user is planning vacation travel to a given destination, the user may be interested in a promotional email from an airline offering a discount to that destination, even if the user is normally not interested in such offers.

Given the above criteria of importance and the expectation that the user will usually respond to questions in messages or track responses by his contacts of whom the users has asked questions, the analysis system may track the following to determine which emails the user will want to read or respond to:
1) Content—using a number of indicators that include but not limited to:
   a. Keywords that identify action verb or verb phrases or commitment words or phrases, as well as special cases such as commitment to purchase or buy
   b. Grammar rules that identify if a sentence or phrase within the email body contains an action item or commitment
   c. Elimination of false positives by identifying verb or verb phrases that do not connote action items or commitments
2) Sender—using a number of indicators that include, but are not limited to:
   a. Importance of the senders: senders with which the user has had conversations
   b. Relative importance based on response latency: how quickly the user responds to the sender
3) Topic or Context—using a number of indicators that include, but are not limited to:
   a. Current topic of discussions that user is interested in
   b. Decreasing interest over time in a topic if there has been no mention in recent conversation
   c. Key interest phrase: the key interest phrase is a text phrase that indicates the context or more specifically, the entity names of the intent to be detected.

The importance may be based on the above factors being quantified. Importance may be determined based on a threshold.

### Intent Detection Implementation

The intent detection architecture that includes the messaging analysis system described herein can be implemented in any email client device or in a server, or can be functionally split across the client and the server. A few example implementations are listed as follows:
1. Analytics running on the client device as shown in FIG. 6: all email processing functions from analytics to user actions or follow-up activities may be contained in the client. More details on these actions and follow-up activities are described below.
2. Analytics running on the server as shown in FIG. 8: all email processing functions from analytics to user actions or follow-up activities may be done by the server
3. Analytics on server and synchronization across multiple client devices: all email processing functions from analytics to user actions or follow-up activities may be done by the server, and a user management module may manage synchronization of the user's actions and follow-ups across multiple messaging client devices.

### Email Priority Analysis System

The priority email analysis rates the relative importance of user's incoming email messages. This is done by the event detection analytics component. The importance ratings assigned by the analysis component can then used to automatically highlight the important messages, or those messages in which request intent or commitment intent are detected.

The criteria by which the analysis component rates message importance will be described below. In the embodiments described herein, the analysis component is divided into three sub-components, which independently assign an importance score to each given message, based on different types of features. The sub-components are listed as follows:
Content Analysis—analysis of important terms (tokens) that occur in the body and subject of a message
Conversation Analysis—analysis of the patterns of prior conversation between the message sender and the user
Surface Analysis—analysis of (pre-defined) features in the body of the message, such as “urgent” or “!” (exclamation mark), message length, etc.

The overall message importance score can be a function such as an aggregated composite (e.g., an arithmetic sum) of the three scores returned by each of the sub-components.

Each sub-component is first trained on a sufficient (˜100-500) number of most recent messages (“training set”) in the inbox and outbox of the user. This yields a data model for each sub-component; models should be periodically retrained. Subsequently, new incoming messages can be evaluated using these models.

To summarize, each sub-component has two main public methods:
Model trainModel (Inbox, Outbox)—training
float rateMessage (Message, Model)—evaluation

A detailed description of different email analysis components is provided in Section 3.

### Analytics Components

The analytics components may include the following components:
Action Detector
Commitment Detector
Topic Analysis
Conversation Analysis
Interaction Analysis
Repeated Text Detector
Tokenizer

### Action Detector

The action detector is a module responsible for detecting action items (i.e., intents of questions or requests) in the email messages. Examples of these questions/requests are:
“Did you get my last message?”
“Please send me an update.”
“Let's work on this tomorrow.”

Detected action items can be used to determine message importance. When intent is detected in a message, the text of that message is highlighted by the user interface to provide the indication to the email recipient.

The action detector is initialized with the grammar rules that are a key component of the event detection analytics described earlier in FIGS. 1-3.

### Grammar Rules

Examples of grammar rules used to detect an action item intent are as follows:
:_Verb=get|send|work|email
+did you_Verb * ?
+please_Verb
+let's_Verb

During initialization, the action detector builds an internal data structure corresponding to the grammar rules.

When a new message is received for analysis, the Action Detector first calls the Tokenization unit to split the message into tokens, and then it scans the resulting sequence of tokens for matching patterns specified by the grammar rules. The list of matching patterns (and their corresponding location(s) in the message) is returned.

### Commitment Detector

The commitment detector is a module responsible for detecting commitments, i.e., (statements made by the sender that imply a promise or a commitment in the email messages. Examples of commitments are:
“I will look into this.”
“Let's meet next week.”
“Tuesday works for me.”

The commitment detector works like Action Detector described earlier, except that it is initialized with a different set of grammar rules designed for detecting commitments.

### Topic Analysis

Topic Analysis determines importance based on the presence of important terms that comprise a topic. Detected topics can be used to determine message importance and/or highlighted by the user interface.

The set of topics and their associated valence scores are determined statistically during training the Topic Analysis on a set of existing email messages.

At a high level, the valence scores are determined by the difference of probabilities of being in the outgoing messages versus incoming messages (i.e. words in the outgoing messages are used as a proxy of what is important to the user).

More specifically:

$$\text{?} \frac{count \text{?}}{count \text{?}} - \frac{count \text{?}}{count \text{?}}$$

$$\text{?} \text{indicates text missing or illegible when filed}$$

This results in a score between 1.0 and −1.0. The higher the score, the more likely a term is to appear in the outgoing messages, and thus the higher is its importance. Conversely, if the term occurs in the incoming messages, but not in outgoing messages, it is probably less important (i.e., messages containing the term are more often ignored).

Words in a predefined stopword list, as well as a custom blacklist are excluded from consideration. Morphological variants (“runs”, “running”) are collapsed into the canonical form (“run”), using a stemming table for common words. Tokens are treated in a case-insensitive way.

The importance of a (new) email message E (and given Topic Analysis model M) is simply the sum of the scores of the valence scores for topics present in the model, possibly normalized by the total length of the message:

$$importance \text{?} importance \text{?}$$

$$\text{?} \text{indicates text missing or illegible when filed}$$

The raw message topic score is normalized by mean and standard deviation of importance scored calculated from the messages in the training set.

### Conversation Analysis

Conversation Analysis determines the importance of a message based on the past patterns of email exchange between the user and the sender of a given message.

The Conversation Analysis model contains a list of email addresses (senders) and the corresponding importance score. The importance score of an email address is proportionate (among other factors) to the difference between the fraction of the outbound messages in the training set sent to the email address and the fraction of the inbound messages received from a given address, i.e.:

$$\text{?} \frac{count \text{?}}{size ( outbox )} - \frac{count \text{?}}{size ( inbox )}$$

$$\text{?} \text{indicates text missing or illegible when filed}$$

The conversation analysis score of a new inbound message is simply the importance score of its sender.

The raw conversation score for a new message is normalized by mean and standard deviation calculated from the inbound messages in the training set.

### Interaction Analysis

Interaction Analysis is used to help predict the importance of certain conversations, topics or persons, based on the past patterns of user interaction (i.e., actions taken with email user interface) on relevant messages.

The Interaction Analysis model takes into account features like:
Time taken to open with respect to other email reading behavior.
Time message remained “open” on device.
How many times that email was opened before taking an action.
Action taken after reading the message.

### Repeated Text Detector

Repeated Text Detector is designed to detect regions of text that are repeated across emails from certain senders (e.g., corporate template, legal disclaimer). These repeated regions are unlikely to contain new information and are excluded from consideration by Action Detector, Commitment Detector and Topic Analysis.

Repeated Text Detector keeps a record of all unique lines seen in previous email messages from each user, together with the corresponding counts. If a given line has been seen more than a minimum number of times in messages from a given user, those lines are considered repetitive. Given a new email message, Repeated Text Detector finds regions that are repeated thus, and should be ignored.

In order to make the Repeated Text Detector robust with respect to minor variations in content, the following types of pattern categories are noticed and replaced with a generic symbol corresponding to each category:
Dates (numeric, months, and days of the week);
Times;
Alphanumeric expressions (containing both numbers and letters);
Email Addresses; and
Web URLs.

### Tokenizer

Tokenizer takes the text of a message or any online posts, and returns a sequence of tokens corresponding to words, punctuation symbols, and special symbols (e.g. start of sentence) in the message. These token sequences are used by other modules (such as Action Detector) to perform analysis.

Care is taken to make sure that URLs, common abbreviations (such as “e.g.”), and idiosyncratic punctuation (e.g. “1)”, “O'Reilly”) are tokenized correctly.

### Email Scoring

The determination of whether an email is flagged (for an Action Item or a Commitment) is based on a function of different scores.

Three components are used currently to determine whether an email is flagged:
Conversation_Score—score from the analysis of the patterns of prior conversation between the message sender and the user
Surface_Score—score from the analysis of (pre-defined) features in the body of the message, such as “urgent” or “!” (exclamation mark), message length, etc.
Content_Score—score from the analysis of important terms (tokens) that occur in the body & subject of a message

As described earlier, the scores are defined as follows:
Conversation_Score: normalized score that indicates if there has been prior conversation between User and the Sender. Score is higher when there is more exchange of email between User and Sender. The score would be 0 if the User never responds or replies to the email from the Sender. High scores indicate that is important to the User. Conversation score of a Sender can be a time-dependent function since the importance of a Sender can increase or decrease over time.
Surface_Score: normalized score that indicates there is a “speech act” in the body of the received email body, or in the header if the initial (i.e., not the reply) had a question or a response request from the Sender for the User. Surface score is independent of the Sender and independent over time since it is only based on “tokens” in the received email body.

Content_Score: indicates that the received email contains words or phrases related to current topics that the User is interested in. Current topic of interest is determined by the related tokens that occur with highest frequency. Content score of a topic is usually a decaying function of time especially as new topics surface in the email conversations.

All scores may be normalized to values between 0 and 1.

### Flagging Important Emails

There are many ways to flag important messages and emails. Here we include two implementations for illustration. In the first case, all emails are flagged with specific symbols or flags on the client email display:
[symbol] : represents an Action Item email which contains a question or request that needs a response from the user
♦: represents an Important email that would be of interest to the user but no Action is expected of the user
∘: represents a FYI (for your information) email where no action is required, and may not of interest to the user—it may be deferred for later reading and to dispense with as the user chooses, including deleting

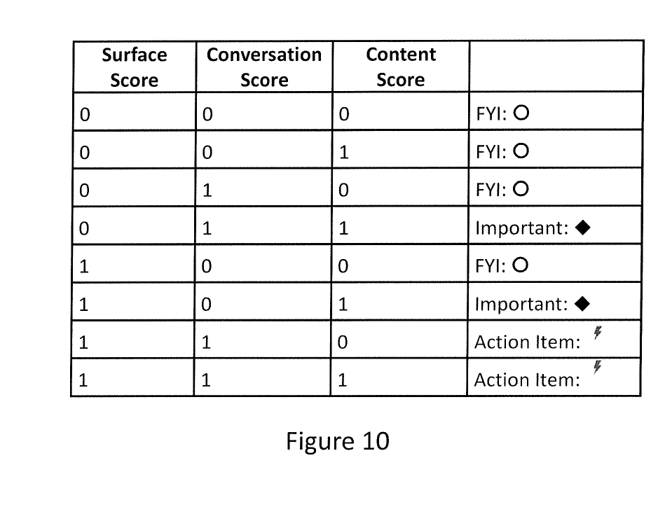

FIG. 10 shows the logic table for the determination of email status flags, after intent detection analytics has been executed on the emails.

The definition for the status value of the Flag is based on the following assumptions:
The Flag is set to Action Item only if both Surface_Score and Conversation_Score are both high.
The Flag is set to Important if Content_Score is high and either the Surface_Score (action required) or the Conversation_Score (Sender is important) is high.
All other cases indicate that the email is not important and the flag is set to FYI.

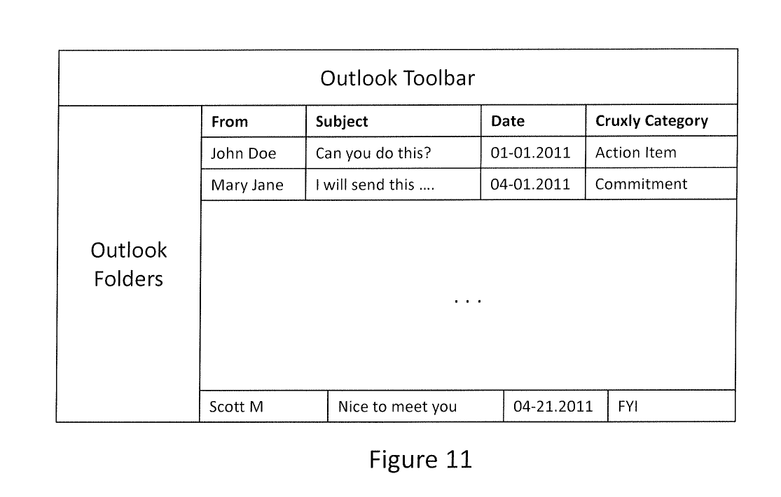

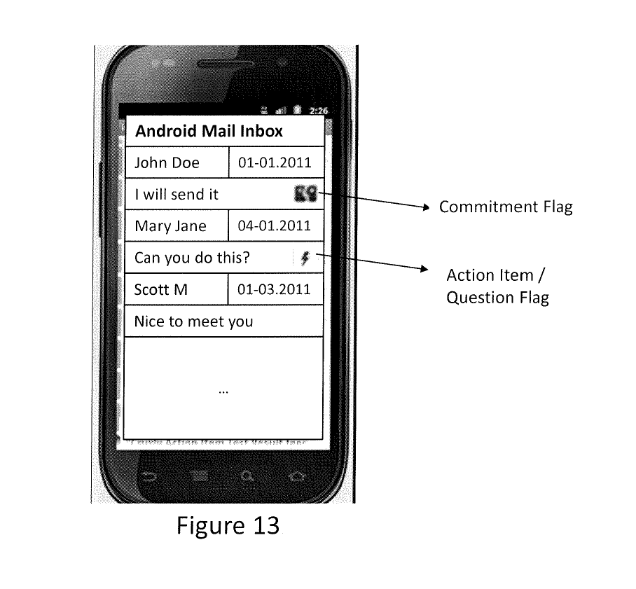

The logic assumed above is based on one interpretation of how emails may be marked or flagged. Examples of the usage of such flags are shown for an embodiment for a desktop email client in FIG. 11 and for a smartphone in FIG. 13. There may be many other ways of flagging the emails that are important to the user.

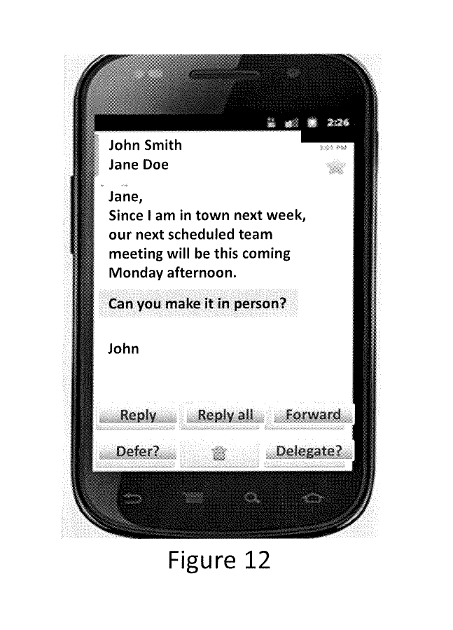

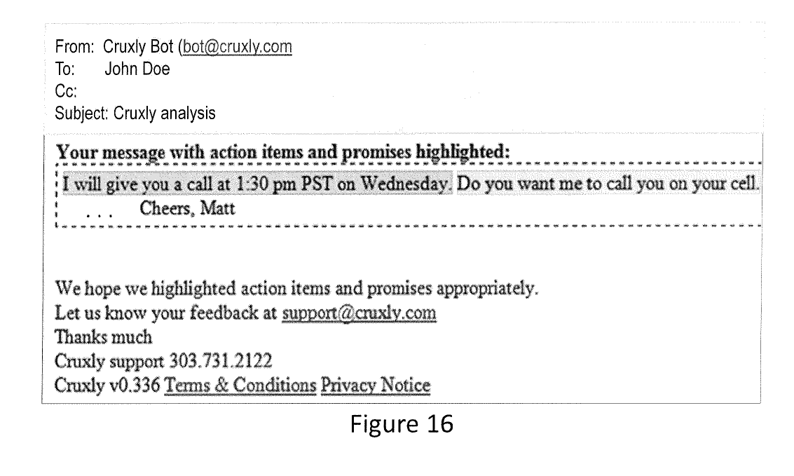

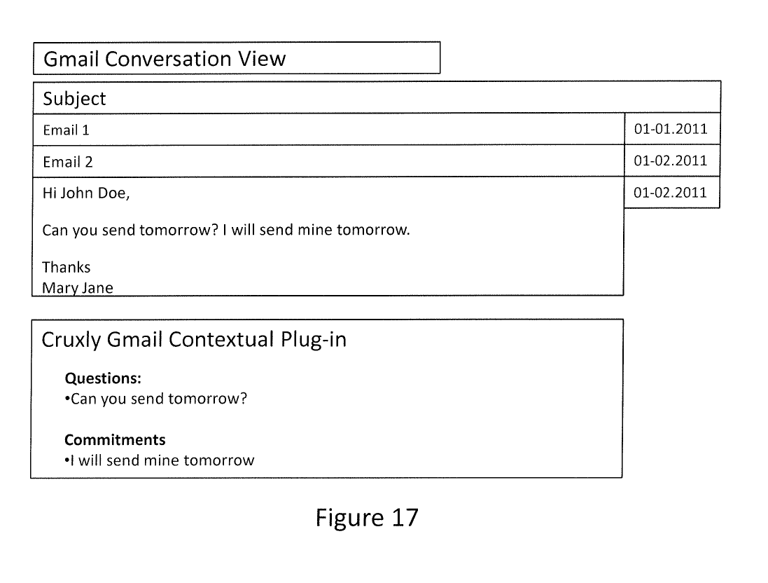

Example embodiments of where the text of a message is highlighted when an intent is detected is shown for two embodiments: FIG. 12 shows highlighting of an action item for a smartphone in FIG. 12, for an email bot in FIG. 16, and for a web mail client in FIG. 17.

### Dashboard: Access to Emails, Schedules, etc.

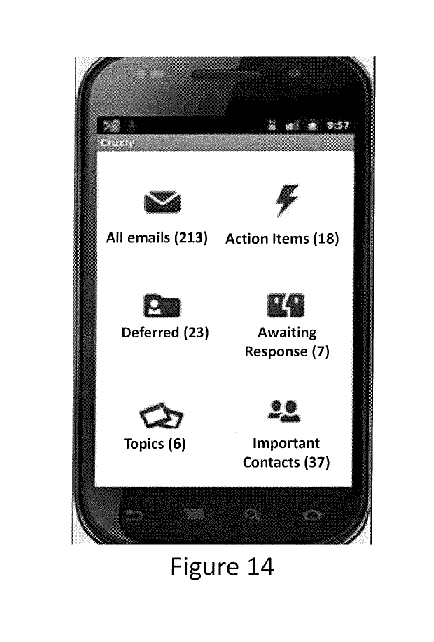

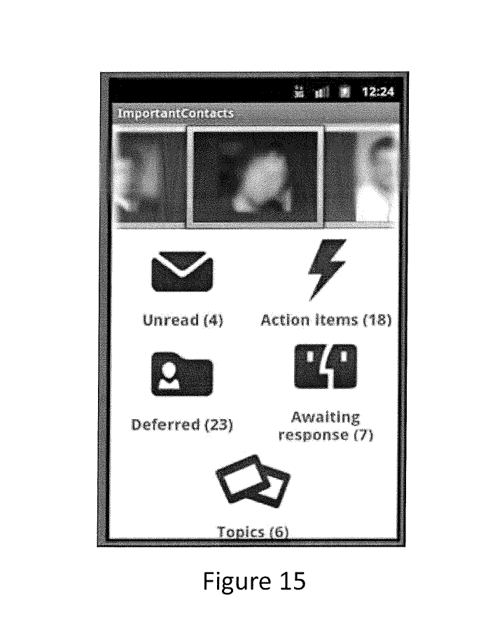

Because different users access their emails differently, particular embodiments have built an email dashboard for users to access email by different criteria. As shown in FIG. 8, a user can access emails by the following categories:
All Emails—the traditional view as shown in the embodiment for a desktop email client in FIG. 11 and for a smartphone in FIG. 13.
Action Items—sorted by those that have been flagged to have action items as shown in the smartphone embodiment of FIG. 14.
Awaiting Response—those emails where the User has sent an Action Item and is waiting for a response, such as a commitment, from the recipient. This also includes emails that have been delegated by the User to a Contact and where the User is awaiting a follow-up from the Contact as shown in the smartphone embodiment of FIG. 14.
Deferred—those emails that had action items that the user still needs to respond to since he/she has deferred the response as shown in the smartphone embodiment of FIG. 14.
Important Contacts—sorted by the Contacts most important to the User, i.e., those Contacts with whom the User has the most conversations as shown in the smartphone embodiment of FIG. 15.
Topics—organized by common topics of discussion in the email.

FIG. 15 shows examples of how some of the above categories of emails are assembled with both automation and analytics executed and with input from the user. Action Items and Awaiting Response are not described below. Deferred and Delegated Emails and the Important Contacts view are instead described.

### Deferred or Delegated Emails

Emails can be deferred by the User on detection of an Action Item. This is one of the options presented as shown in the smartphone embodiment of FIG. 12.

### Important Contacts View

Another common view that is desired by user is to view emails from the user's most Important Contacts, the contacts the user has the most frequent conversations via email.

Because particular embodiments analyze Conversations by Contact using the Conversation Analysis, it can automatically sort the most important contacts, and also show Unread emails from the Contact, Action Items owed to the User, Emails deferred to the Contact, emails to the Contact that the User is awaiting a response, and emails sorted by Topics.

Event Detection web-based API

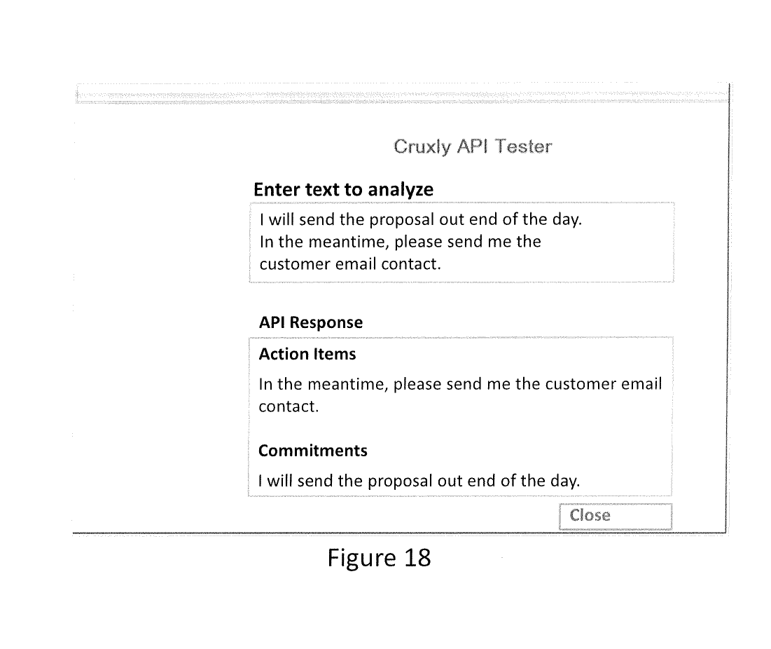

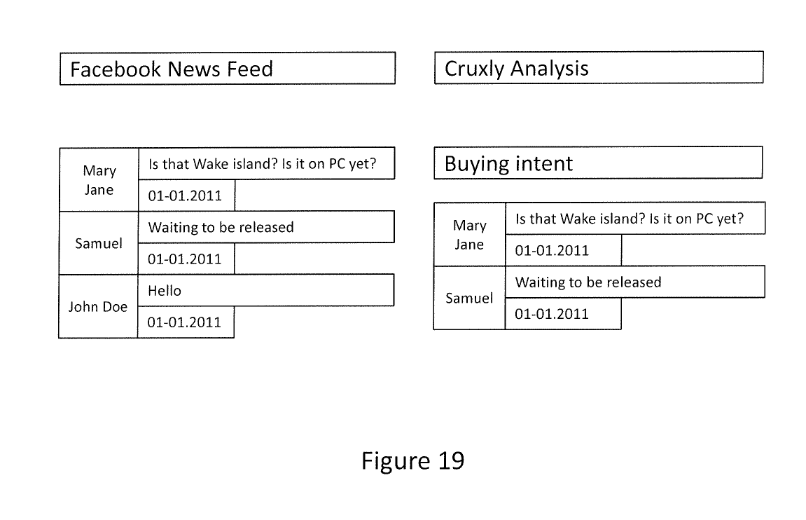

Besides the embodiment for email applications, another class of embodiments is a web based API. An embodiment of this is shown in FIG. 18. Another application of integrating such an API is when online posts on a web site including posts on a social media site are analyzed for intent detection. One such embodiment of detecting the action item or commitment intents for posts on a social media website is shown in FIG. 19

Special application for Intent Detection for CRM

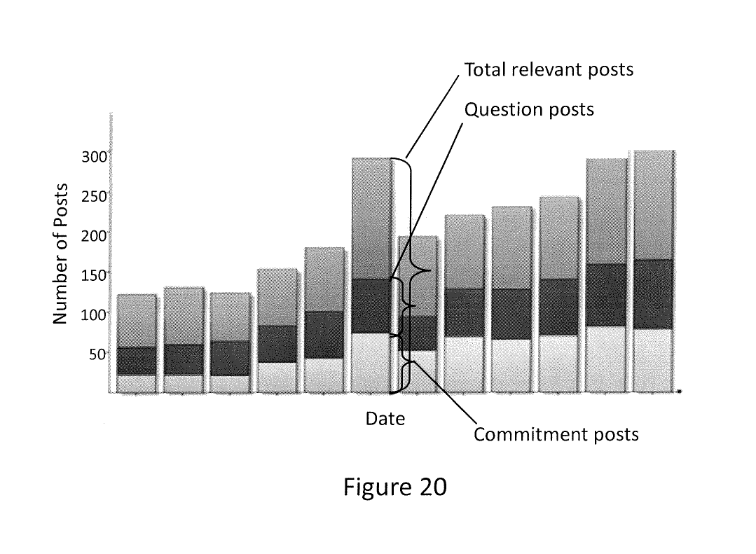

A special case of using event and intent detection is in the case of customer support. Sales personnel are in frequent email communication with existing or prospective customers containing questions and commitments to follow up. The customer support department usually sends initial response within 2-3 hours of first receiving email acknowledging the issue and if possible, some kind of workaround or resolution and follow up with detailed response within a day. Intent detection analytics can be used to detect question from customers by support personnel in incoming emails. It can also be used to track the commitments made by support personnel to customers. By using intent detection together with topic detection allows the customer support department to build an email plug-in that can surface high risk emails allowing personnel to respond to them quicker. Upon responding, customer support supervisor can pull out a report of all commitments made by personnel and get better view of current status. FIG. 20 shows an embodiment of a dashboard that is used to track issues raised by customers and commitments made by personnel for a given customer over a timeline.

### An Illustrative Example of Processing for Event Detection Analytics

A simple limited example of how an event detection analytics system is set up for a predefined event is now provided. The steps used in the process to derive the event detection logic are shown in FIGS. 2 and 4.

Event: message sender intends “to buy a computer”
Data Sources: email and social media posts

In this example it will be assumed that process for text extraction 100, tokenization 201, and t segmentation 202 of the email or post text from the data source has been done. The primary steps in setting up the analytics are those that define the event detection logic 150.

The event definition 120 in FIG. 4 requires defining different constructs for the event where the sender expresses intent to purchase a computer.

To create a number of primary constructs 420, and limiting only to those in this example, the following simple expressions are considered:
“We will get a laptop.”
“I could order a Mac online.”
“Gonna buy a computer today.”

As part of the process to categorize the primary constructs 440, different verb expressions related to “buying” are considered. The set of verbs related to buying or “purchasing” may include a list synonyms and equivalent expressions. The following set “:purchase” is an example:

:purchase=acquire|bid|buy|purchase|cop|earn|corral|collect|catch|finance|gather|get|grab|have|obtain|pay|pick|procure|secure|rack up|rebuy|repurchase|win|sign off|employ|hire|contract|engage|enroll|register|order|rent|scoop up|shop|snag|snap up|

Similarly, the set of nouns describing the computer may include all forms of “computer”. The following set “:computer” is an example:

:computer: computer|laptop|netbook|notebook|desktop|PC|Mac

Based on the above, ne simple set of grammar rules 450 would include:
+_IWeSimple_Will_purchase_Articles?_computer
+_IWeFuture_purchase_Articles?_computer
+_IWeWould_purchase_Articles?_computer
+˜PHRASE_START_IWe? going to_purchase_Articles?_computer
+˜PHRASE_START_IWe? gonna_purchase_Articles?_computer
+˜PHRASE_START_IWe? wanna_purchase_Articles?_computer
+˜PHRASE_START_IWe? want to_purchase_Articles?_computer

The above form of the grammar is based on the syntax the parser uses to process the message or post. In the above the different sets such as IWeSimple refer to word sets used for pronouns, verbs forms and articles and are defined as:
:IWeSimple=i|we
:IWeFuture=i'll|we'll
:Iwe=i|we|i'd|we'd|i'm|we're|i'll|we'll|i'm|we're
:Will=will|shall|would|should|could
:Articles: a|an|the

The event detection logic 150 in FIG. 2 that uses the above set of grammar rules correctly identifies the intent to buy a computer as per the examples that were listed earlier. The above example serves to illustrate how the method described herein is used to set up the analytics for event detection. Based on the foregoing analysis, the system may output an indication that the sender of the message intends to buy a computer.

### Embodiment Approach

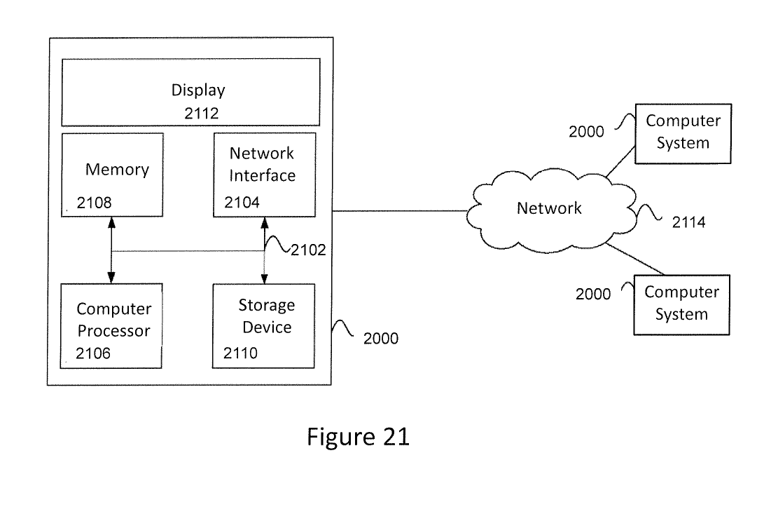

FIG. 21 illustrates an example of a special purpose computer system 2000 configured with an event detection system according to one embodiment. Computer system 2000 includes a bus 2002, network interface 2004, a computer processor 2106, a memory 2108, a storage device 2110, and a display 2112.

Bus 2002 may be a communication mechanism for communicating information Computer processor 2004 may execute computer programs stored in memory 2108 or storage device 2110. Any suitable programming language can be used to implement the routines of particular embodiments including C, C++, Java, assembly language, etc. Different programming techniques can be employed such as procedural or object oriented. The routines can execute on a single computer system 2000 or multiple computer systems 2000. Further, multiple processors 2106 may be used.

Memory 2108 may store instructions, such as source code or binary code, for performing the techniques described above. Memory 2108 may also be used for storing variables or other intermediate information during execution of instructions to be executed by processor 2106. Examples of memory 2108 include random access memory (RAM), read only memory (ROM), or both.

Storage device 2110 may also store instructions, such as source code or binary code, for performing the techniques described above. Storage device 2110 may additionally store data used and manipulated by computer processor 2106. For example, storage device 2110 may be a database that is accessed by computer system 2000. Other examples of storage device 2110 include random access memory (RAM), read only memory (ROM), a hard drive, a magnetic disk, an optical disk, a CD-ROM, a DVD, a flash memory, a USB memory card, or any other medium from which a computer can read.

Memory 2108 or storage device 2110 may be an example of a non-transitory computer-readable storage medium for use by or in connection with computer system 2000. The computer-readable storage medium contains instructions for controlling a computer system to be operable to perform functions described by particular embodiments. The instructions, when executed by one or more computer processors, may be operable to perform that which is described in particular embodiments.

Computer system 2000 includes a display 2112 for displaying information to a computer user. Display 2112 may display a user interface used by a user to interact with computer system 2000.

Computer system 2000 also includes a network interface 2004 to provide data communication connection over a network, such as a local area network (LAN) or wide area network (WAN). Wireless networks may also be used. In any such implementation, network interface 2004 sends and receives electrical, electromagnetic, or optical signals that carry digital data streams representing various types of information.

Computer system 2000 can send and receive information through network interface 2004 across a network 2114, which may be an Intranet or the Internet. Computer system 2000 may interact with other computer systems 2000 through network 2114. In some examples, client-server communications occur through network 2114. Also, implementations of particular embodiments may be distributed across computer systems 2000 through network 2114.

The methods described above may be performed by a computer by running computer-readable instructions. The methods may also be performed using an ASIC or other device.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents may be employed without departing from the scope of the invention as defined by the claims.

What is claimed is:

1. A method for analyzing text, said method comprising:
providing first text in a computer-readable format;
tokenizing the first text to yield units of the first text;
segmenting the units of first text to yield second text;
parsing the second text to yield parsed second text;
correlating at least one grammar rule to the parsed second text;
providing a message as to the purpose of the first text based on the at least one correlated grammar rule.

2. The method of claim 1, wherein providing a message comprises providing an indication message as to the purpose of the first text based on the at least one correlated grammar rule.

3. The method of claim 1 wherein the purpose includes an inquiry.

4. The method of claim 1 wherein the purpose includes a predetermined event.

5. The method of claim 1, wherein the purpose includes a specific action.

6. The method of claim 1, wherein the purpose includes an intent to perform a specific action.

7. The method of claim 1, wherein the purpose includes predetermined information related to a named entity.

8. The method of claim 1, wherein the at least one grammar rule includes a predetermined sequence of units.

9. The method of claim 1, wherein the at least one grammar rule includes a predetermined combination of units.

10. The method of claim 1 and further comprising analyzing the parsed second text based on at least one correlated grammar rule to detect specific information related to the purpose.

11. The method of claim 10, wherein the specific information relates to the time.

12. The method of claim 10, wherein the specific information relates to entities related to the purpose.

13. The method of claim 10, wherein the specific information relates to the location of the purpose.

14. The method of claim 10, wherein the specific information relates to the sentiment of the second text.

15. The method of claim 1, wherein the purpose relates to an intent to purchase an item.

16. The method of claim 14, and further comprising analyzing the parsed second text to determine the item that is intended to be purchased.

17. The method of claim 1, wherein the purpose relates to the dissemination of information.

18. The method of claim 17, and further comprising analyzing the parsed second text to determine the topic of the information.

19. The method of claim 17, wherein the information is related to at least one predetermined named entity.

20. A method for analyzing text, said method comprising:
providing first text in a computer-readable format;
tokenizing the first text to yield units of the first text;
segmenting the units of first text to yield second text;
parsing the second text to yield parsed second text;
correlating at least one grammar rule to the parsed second text; and
providing a message as to the purpose of the first text based on the at least one correlated grammar rule; wherein the message comprises providing an indication as to the purpose of the first text based on the at least one correlated grammar rule; wherein the purpose may include a predetermined event, an inquiry, a specific action, an intent to perform a specific action; and
disseminating the information related to a named entity or time or location or sentiment.
